(19) United States
(12) Patent Application Publication
(10) Pub. No.: US 2025/0206412 A1
(43) Pub. Date: Jun. 26, 2025

(54) SIGNAL TRANSMITTER FOR A GEAR CHANGING APPARATUS FOR A BICYCLE

(71) Applicant: PORSCHE EBIKE PERFORMANCE GMBH, OTTOBRUNN (DE)

(72) Inventor: JOHANNES BIECHELE, RIEDERING (DE)

(73) Assignee: PORSCHE EBIKE PERFORMANCE GMBH, OTTOBRUNN (DE)

(21) Appl. No.: 18/846,278

(22) PCT Filed: Mar. 17, 2023
(86) PCT No.: PCT/EP2023/056897

§ 371 Date: Sep. 12, 2024

(30) Foreign Application Priority Data
Mar. 18, 2022 (DE) 10 2022 106 451.4

(51) Int. Cl. B62M 25/08; B62K 23/02; B62M 9/122; H01F 7/06

(52) U.S. Cl. CPC B62M 25/08; B62K 23/02; B62M 9/122; H01F 7/064

(57) ABSTRACT

A signal transmitter for a shifter apparatus for a bicycle. The signal transmitter includes an annular transmitter base, a sensor which generates transmitter signals, and an annular operating element which can be joined to the annular transmitter base to jointly form a feed-through opening which accommodate a bicycle handlebar. The annular operating element includes a magnet and can be held in a neutral position on the annular transmitter base by the magnet so that, starting therefrom, the annular operating element is operatable to perform a rotational movement relative to the annular transmitter base in any direction about a longitudinal axis of the feed-through opening, and to perform a tilting movement relative to the annular transmitter base. The transmitter signals generated by the sensor correspond to a specific rotational movement or to a specific tilting movement of the annular operating element.

The present invention relates to a signal transmitter for a shifter apparatus for a bicycle and a shifter apparatus and a bicycle. The invention further relates to a method for assembly of a signal transmitter and a method for operating a signal transmitter.

In the technical field of bicycles, mechanical and electrical shifters and signal transmitters have been known for a long time. They are used e.g. when controlling gear shifting systems or lighting systems.

Signal transmitters are distinguished in that they only generate one reference variable or control variable (for simplicity, a “reference variable” will always be used here). This can for example be a mechanical or electrical signal or else a mixture or chain of mechanical and electrical signals. In general, such signals are output as voltage or current signals. The signal of the signal transmitter in this case influences a system that is to be controlled in an open-loop or closed-loop manner, also termed an open-loop or closed-loop controlled system (for simplicity, a “controlled system” will always be used here), not directly, but rather influences a final control element which in turn acts on the controlled system.

In the field of bicycles, a simple lighting device may be mentioned as an example. The lighting device may for example comprise a push-button as signal transmitter, which initially transmits a mechanical signal to internal electronics. The electronics can for example generate a voltage signal from this as reference variable, which is then in turn forwarded to power electronics as a final control element for actually activating or deactivating a light source as controlled system.

Shifters are in turn distinguished in that they function directly as final control element. In the bicycle sector, a mechanical gear shifting system could be mentioned here by way of example, which adjusts the bicycle gear mechanism (as controlled system) directly by means of the tension of a cable (as final control element). A simple electrical switch can likewise be mentioned by way of example, which directly opens or closes a power connection.

In the sector of electric bicycles, for example e-bikes or pedelecs, which is becoming increasingly popular, an electrical energy source, e.g. a battery or a rechargeable battery, is provided in the bicycle as standard. The energy stored in it enables mechanization of the work which has hitherto been performed only by humans, particularly in the form of power assistance during pedalling (pedelecs). This can however go as far as automatic drive of the bicycle (e-bikes).

In the course of electrification, digitalization is also progressing in the field of electric bicycles, as additional functions can be implemented particularly easily due to the electrical energy source. It must be possible to operate additional functions by means of suitable signal transmitters, in addition to the standard functions, such as “upshifting”, “downshifting”, “lighting system on” or “lighting system off”, for example. Additional functions may, purely by way of example, comprise a selection of shifting characteristics, generation of additional communication signals (such as flashing) or else a speed-limiting function.

As a result, a trend towards increasing function density is associated with the electrification and digitalization, which must be reflected within the limited installation space for a bicycle. Of course, an increase in function density may also take place in the case of conventional bicycles having a suitable energy source or in the case of completely different technical systems outside of the bicycle sector.

The present invention is based on the object of proposing a signal transmitter for a shifter apparatus for a bicycle, which can generate a wide range of different shifting signals with little outlay. Furthermore, a simplest possible method for assembly of such a signal transmitter should be enabled. Finally, one object of the invention is to propose a method for operating a signal transmitter and a shifter apparatus for a bicycle, using which a high function density can be provided for the bicycle with the aid of different shifting signals with simple operation.

The object is achieved by the subjects of the independent Claims 1, 10, 12, 13 and 15. Preferred embodiments of the present invention can be found in the features mentioned in the dependent claims and furthermore from the present disclosure as a whole.

A first aspect of the invention relates to a signal transmitter for a shifter apparatus for a bicycle, comprising an annular transmitter base and an annular operating element which can be or is joined to the annular transmitter base, so that the annular transmitter base and the annular operating element together form a feed-through opening for accommodating a handlebar of the bicycle. In this case, the annular operating element has at least one magnet and is configured in such a manner that the annular operating element can be or is held in a neutral position on the annular transmitter base by the at least one magnet and that, starting from the neutral position, the annular operating element can be operated at least as follows:
carrying out a rotational movement of the annular operating element relative to the annular transmitter base in any direction about a longitudinal axis of the feed-through opening, and
carrying out a tilting movement of the annular operating element relative to the annular transmitter base.

In this case, the signal transmitter further comprises at least one sensor for generating transmitter signals which in each case correspond to a specific rotational movement or tilting movement of the annular operating element.

It is important in the present case that the signal transmitter according to the invention comprises a base ring and an operating ring which can be moved relatively thereto, wherein the operating ring is preferably arranged concentrically on the base ring. In this manner, the handlebar of the bicycle can be pushed through the base ring and the operating ring. The operating ring is magnetically held on the base ring in a neutral starting position. In this starting position, the operating ring, still preferably in concentric arrangement, can be rotated with respect to the base ring and/or tilted with respect to the base ring. Depending on the movement of the operating ring, a sensor generates a specific transmitter signal for this, which can be used as a reference variable for controlling a particular function.

To keep the language used simple, “base ring” or “operating ring” will still be used occasionally here, wherein the annular transmitter base and the annular operating element respectively are always what is meant.

The functions that can be controlled using the specific transmitter signals as reference variable may, purely by way of example, comprise: upshifting, downshifting, switching on lighting system, switching off lighting system, dimming lighting system, selecting shifting characteristics for the shifter apparatus, generating a visual and/or acoustic communication signal, activating or deactivating or even adjusting a speed-limiting function. Here, many further functions are conceivable, which may be useful in the bicycle sector or else in a non-bicycle sector.

Preferably, the operating ring comprises an operating section on its external circumference, which enables a secure and convenient operating action (rotating and/or tilting of the operating ring by the rider) from the neutral position, preferably using the thumb. The operating section can preferably protrude from the external circumference, for example as an operating nub. It may however also be recessed into the external circumference, for example as an operating dimple.

The signal transmitter of the invention enables the generation of a multiplicity of different transmitter signals. However, at least three transmitter signals can be generated, namely—in a viewing direction onto the feed-through opening—by rotating the operating ring to the left, by rotating the operating ring to the right and also by tilting the operating ring in a certain direction. Depending on the type of the sensor and the manner in which further processing of its transmitter signals takes place, for example by means of a control device of the bicycle, both discrete and continuous transmitter signals can be generated and processed.

Discrete transmitter signals may for example be present as logical 0 or 1, expressed by a voltage or current signal. A transmitter signal of this type can for example correspond to a state of the operating ring, which is either tilted or not tilted. For example, the operating ring can also be tilted in a plurality of directions. By way of example, such a discrete transmitter signal may read as follows: “tilting direction 1=1; tilting direction 2=0; tilted=1”. This could for example correspond to a tilting movement in a first direction.

Continuous transmitter signals may for example be present within a range of a voltage or current level, purely by way of example between 0 V and 5 V. One such continuous transmitter signal may for example also correspond, in addition to a tilting and/or rotating direction, to a degree of the tilting and/or rotational movement. By way of example, such a continuous transmitter signal may read as follows: rotating direction 1=0; rotating direction 2=1; rotation=2.5 V. This could for example correspond to a slight rotational movement in a second direction. A value “rotation=5 V” could by contrast correspond to a strong rotational movement.

Therefore, almost any multiplicity of specific transmitter signals can be generated with little outlay using the signal transmitter according to the invention.

At the same time, the signal transmitter according to the invention is simply built and compact, as it manages even with only two parts or sub-assemblies which can be moved relatively to one another, namely the annular operating element and the annular transmitter base. The signal transmitter according to the invention is additionally very robust and can be produced with little outlay. Sensitive components, such as the sensor or the magnet can preferably be integrated in the annular operating element or the annular transmitter base, particularly preferably encapsulated therein. The annular operating element and the annular transmitter base can be produced preferably at least to some extent from plastic.

The intuitive operability of the signal transmitter according to the invention is particularly advantageous. If this is mounted on the handlebar as intended, then—as viewed in the forwards—facing direction of travel—the operating ring can for example be rotated forwards (away from the rider) for upshifting and rotated backwards (towards the rider) for downshifting. Movement characteristics of the operating ring may, for example using a movement restriction, have the character of a “shifting mechanism operable by tapping”. This is not only haptically pleasant, rather it assists the fast and secure generation of unique transmitter signals by short and precise operating paths at the same time. Due to the annular shape of the operating element, a particularly fast change between the rotational and tilting movements is possible without changing grip. This results in a lower strain for the rider, which allows a higher degree of concentration on actual riding. Therefore, the signal transmitter of the invention also increases the safety of a bicycle equipped with it. Both the rotational and the tilting movements can advantageously be carried out using the thumb without it being necessary to change grip to do this for example.

The kinematics and sensor technology of the signal transmitter according to the invention shall be discussed in more detail in the following. First, it is noted that in the case of tilting of the operating ring, this operating ring is strictly speaking no longer arranged concentrically with the base ring. In the context of the invention, the operating ring is however considered to be arranged concentrically with the base ring as long as the handlebar can be guided as intended through the jointly formed feed-through opening. The handlebar may for example have a diameter of 20 mm to 25 mm, preferably 22 mm to 24 mm. Particularly preferably, the diameter may be 22.2 mm or 23.5 mm. An internal diameter of the annular transmitter base and an internal diameter of the annular operating element may correspond to this and be designed to fit with a corresponding tolerance. Preferably, the internal diameter of the base ring is somewhat narrower than the internal diameter of the operating ring, so that the handlebar is are guided securely through the base ring and the operating ring at the same time can have the desired movability for rotating and tilting. Preferably, the internal diameter of the operating ring is designed in such a manner with a tolerance that this operating ring is configured to be tiltable by up to 10° when the handlebar is located in the common feed-through opening. For example, the operating ring can be configured to be tiltable by up to 9°, 8°, 7°, 6°, 5°, 4°, 3°, 2° or 1°. In principle, tilting by a larger angle is also conceivable.

The tilting by a specified angle can be measured in such a manner that planes formed by the two base surfaces which are directed towards one another, one of the annular operating element and one of the annular transmitter base, run substantially parallel to one another without a tilt of the annular operating element. If the operating ring is then tilted with respect to the base ring by a specified angle, then the plane formed by that base surface of the operating ring is tilted by that angle with respect to the plane that remains static, which plane is formed by that base surface of the base ring.

According to one embodiment, the annular operating element is configured to be tiltable by up to 5.5°. A movement restriction of this type may represent a good value for the tilting movement in the bicycle sector in order to ensure a shifting path in the tilting movement which is clearly haptically discernible and short and precise at the same time.

With respect to the rotational movement and/or tilting movement, a movement restriction may for example also be realized by suitable stops between the base and the operating ring when the operating ring is joined to the base ring.

With regards to the rotational movement, the operating ring is preferably rotatable by up to 40° in one or both directions. For example, the operating ring can be configured to be rotatable by up to 35°, 30°, 25°, 20°, 15°, 10° or 5°. Larger angles of rotation are also conceivable.

The rotation about a specified angle can be measured in such a manner that, as viewed in a viewing direction onto the feed-through opening, from a neutral position, the operating ring can be rotated by the specified angle at least in one direction (to the left or right in the viewing direction mentioned) or preferably in both directions. For illustration purposes only, it is noted that, as viewed in the viewing direction onto the feed-through opening, a rotation to the right by 360° would accordingly correspond to a complete rotation of the operating ring until it is back in its starting position.

According to one embodiment, the annular operating element is configured to be rotatable by up to 30.0° in both rotating directions. A movement restriction of this type may represent an optimum value for the rotational movement in the bicycle sector in order to ensure a shifting path in the rotational movement which is clearly haptically discernible and short and precise at the same time.

For all of the aforementioned rotational and tilting values, all intermediate values are also disclosed with respect to the invention, provided that the base ring, the operating ring and the movement restriction can be realized accordingly within the tolerances of known production methods, in order to realize the possible rotational or tilting movement accordingly. This applies also for any intervals which may be formed by the disclosed values and their intermediate values.

As stated, the operating ring can be joined to the base ring. “Can be joined to” means that the signal transmitter of the invention can also be considered as a system of its individual components and may be present as a kit for the purpose of transport for example.

When the operating ring is joined to the base ring, at least one placement surface of the annular transmitter base is in contact with a bearing surface of the annular operating element. Although, in the sense of the invention, “joined to” implies a physical contact, not necessarily a self-holding connection. To test the signal transmitter prior to final assembly on the bicycle, the operating ring can for example also be joined to the base ring in the sense of pre-assembly and held there manually and/or by the magnet. This increases the certainty that the signal transmitter functions as intended following the (final) assembly on the bicycle. A self-holding connection can however absolutely also be realized prior to the assembly on the bicycle. This can take place e.g. by means of the magnet which is configured to be strong enough for this purpose, in order to hold the operating ring on the base ring. Additional magnets may also be used, which fulfil this purpose at least overall. The self-holding connection can also be assisted or achieved by the handlebar arranged in the common feed-through opening, in that the handlebar at least indirectly prevents the operating ring from being able to tilt off the base ring completely. If required, additional connecting means may also be provided, such as connecting structures on the base and operating rings for example.

As stated previously, the operating ring can be held on the base ring in the neutral position by the magnet. This in particular includes it being possible to move the operating ring out of the neutral position by means of the operating action of the rider (rotating and/or tilting) and the magnet being able to move the operating ring back into the neutral position after the operating action has ceased. This in particular also includes the operating ring being held in the neutral position provided that no operating action is taking place. Accordingly, the magnet or the magnets can be configured in such a manner that it/they hold(s) the operating ring both joined to the base ring and in the neutral position.

With respect to the rotational and tilting movement, it can clearly be assumed that the base ring and the operating ring in each case have a coordinate system of their own. This is not a physical feature, but rather is defined expediently for an examination that is to be carried out. In the context of the present disclosure, it is therefore assumed that an X-Y plane of the base ring is located in a feed-through opening of the base ring and an X-Y plane of the operating ring is located in a feed-through opening of the operating ring. A Z axis of the base ring forms a longitudinal axis of the feed-through opening of the base ring and a Z axis of the operating ring forms a longitudinal axis of the feed-through opening of the operating ring. If the bearing surface of the operating ring is joined as intended to the placement surface of the base ring and if the operating ring is in the neutral position with respect to the base ring (not rotated/not tilted), then the Z axes are arranged collinearly and run through the then jointly formed feed-through opening of the signal transmitter. In the neutral position, they therefore also run collinearly to a longitudinal axis of the jointly formed feed-through opening and form a Z axis of the signal transmitter as a whole. As intended, they can therefore also run collinearly to a longitudinal axis of the handlebar when the handlebar is arranged in the common feed-through opening. X and Y axes of the own coordinate systems of the operating ring and the base ring, which two axes span the respective X-Y plane of the operating ring and the base ring respectively, are arranged parallel or collinearly to one another in this case.

A pure rotational movement of the operating ring can take place from the neutral position in that the X and Y axis of the operating ring are moved out of their position parallel or collinear to the X and Y axes of the base ring and in the process the Z axis of the operating and base rings continue to remain collinearly arranged.

A pure tilting movement of the operating ring out of the neutral position can take place in that the Z axis of the operating ring is inclined with respect to the Z axis of the base ring without the origins of the coordinate systems of the operating ring and the base ring being moved out of their prior relative positions in the process. Depending on the direction of the tilting movement, the X axis and/or the Y axis of the operating ring can in the process be moved out of its parallel or collinear position with respect to the X-axis and/or the y-axis of the base ring.

The rotational movement and the tilting movement can accordingly also be executed in an overlaid (superposed) manner. Preferably however, movement separation takes place, so either the rotational movement or the tilting movement can be executed.

It is noted that in principle here, intended movements are assumed, which occur as a consequence of an operating action and which are large enough to generate the specific transmitter signal, so that they ensure a sufficient detectability by the sensor. As is conventional in the case of mechanical systems, other movements may be possible in smaller areas due to tolerances.

The sensor or sensors provided for generating the specific transmitter signals may for example be a magnet-sensitive sensor or else an optical sensor. Purely by way of example, in the case of a magnet-sensitive sensor, the change of a magnetic field may be representative for a certain movement. For example, at least one magnet can be provided in the operating ring and at least one magnet-sensitive sensor can be provided in the base ring. In the case of an optical sensor, purely by way of example, the change of a light intensity may be representative for a certain movement. For example, at least one source of at least one wavelength can be provided in the operating ring and at least one receiver for at least one wavelength can be provided in the base ring (or vice versa). Also, the operating ring can comprise a reflector and both the source and the receiver can be arranged in the base ring. For example, magnets of specific strength or specific wavelengths can be used in order to differentiate rotational movements or tilting movements or else their directions. This can also be realized with a plurality of sensors. In principle, different sensors come into consideration, which are able to convert the above-described relative rotational and/or tilting movements into transmitter signals that are specific for them.

The sensors are preferably configured such in this case that intended movements are detected and only movements due to tolerances are filtered out. This preferably takes place by means of a minimum signal level or noise filter.

In a preferred embodiment of the signal transmitter of the invention, it is provided that the annular transmitter base comprises a guide section and the annular operating element comprises a guidable section which guidable section is designed in a complementary manner to the guide section. In this case, the guide section interacts with the guidable section in such a manner when the annular operating element is joined to the annular transmitter base that at least the following condition(s) is/are fulfilled:
whilst the rotational movement of the annular operating element is being carried out relative to the annular transmitter base, starting from the neutral position, essentially no tilting movement is possible, and/or
whilst the tilting movement of the annular operating element is being carried out relative to the annular transmitter base, starting from the neutral position, essentially no rotational movement is possible.

In other words, the previously addressed movement separation is taking place here, for example by means of suitable stops on the guide section and guidable section, which can preferably also be used for movement restriction. It is also self-evident here that the formulations “essentially no tilting movement” and “essentially no rotational movement” take account of the fact that only intended or detectable movements should be permitted. This does not exclude it being possible that different movements can also take place in small ranges due to tolerances.

The guide section and the guidable section can preferably also contribute to arranging the operating ring concentrically to the base ring, as a result of which the guide section and the guidable section are used not only as movement separation or restriction, but rather also as connecting structures. For example, the guide section can be designed in the manner of a collar, connecting piece or flange. The guide section may for example have the placement surface and a guide connecting piece that protrudes from the same along the Z axis. The guide connecting piece can be involved for example in the shaping of the feed-through opening of the base ring and have the internal diameter of the base ring for example. The guide connecting piece can accordingly also be intended for accommodating the handlebar. The guidable section of the operating ring can accordingly be involved for example in the shaping of the feed-through opening of the operating ring and have the internal diameter of the operating ring for example. This is then preferably somewhat larger than the external diameter of the guide connecting piece. Therefore, the operating ring can be pushed concentrically onto the guide connecting piece and be designed with a tolerance in such a manner that it has the necessary clearance for carrying out the tilting and rotational movements, as explained previously. At the same time, the guidable section may have the bearing surface which can be in contact with the placement surface.

In this manner, a broad functional spectrum can be covered with regards to the assembly and the operation of the signal transmitter of the invention in an extremely compact design and in particular with a small number of movable individual components or sub-assemblies.

In a preferred embodiment of the signal transmitter of the invention, it is provided that the guidable section comprises a recess on an end face of the annular operating element, which recess runs in two planes at different depths, wherein the two planes at different depths are designed as a shallow plane and as a deep plane. In this case, the guide section can be or is brought into engagement with the recess in such a manner that the recess:
restricts the rotational movement and prevents the tilting movement on the shallow plane, and/or
prevents the rotational movement and restricts the tilting movement on the deep plane.

In the assembled state of the signal transmitter, the aforementioned end face of the annular operating element preferably faces away from the base ring and is preferably located opposite the previously described bearing surface of the guidable section. The bearing surface then faces the base ring in the assembled state and bears against the same or its placement surface. With respect to the Z axis of the annular operating element, this can also be expressed as follows: If the coordinate origin of the coordinate system of the operating ring is located between its end face and its bearing surface, then the end face is located at a positive Z-coordinate and the bearing surface is located at a negative Z-coordinate.

With respect to the Z-coordinate, the deep plane is deeper than the shallow plane. In other words, from the end face, the deep plane extends further in the negative Z direction than the shallow plane. The deep plane can preferably extend further in the negative Z direction from a base of the shallow plane.

When considered functionally, the guide section can therefore interact with the guidable section so that on the one hand, a rotational movement about the Z axis is enabled in a sliding manner over the base of the shallow plane and at the same time, the base as a stop prevents a tilting movement (movement separation). The rotational movement is preferably restricted by side walls of the shallow plane as stops in this case (movement restriction). Alternatively, the guide section can also interact with the guidable section in such a manner that a tilting movement is enabled as far as a base of the deep plane (movement restriction) as stop and in the process a rotational movement is preferably prevented by side walls of the deep plane as stops (movement separation).

Thus, with little structural complexity, the movement restriction and the movement separation can be achieved with regards to the rotational and tilting movements. This is particularly advantageous in order for example to guide the thumb of the rider reliably and ensure uniquely defined movements for generating the specific transmitter signals for this.

In a preferred embodiment of the signal transmitter of the invention, it is provided that the annular transmitter base comprises a/the guide section and the annular operating element comprises a/the guidable section which guidable section is designed in a complementary manner to the guide section. In this case, the guide section interacts with the guidable section in such a manner, when the annular operating element is joined to the annular transmitter base, that the guide section secures the annular operating element along the longitudinal axis of the feed-through opening when the handlebar of the bicycle is accommodated in the feed-through opening.

For this purpose, the guide section can for example comprise a securing section which is arranged in front of the end face of the operating ring when the signal transmitter is assembled on the handlebar. Following on from the previously mentioned example, in which the end face is located at a positive Z-coordinate and the bearing surface is located at a negative Z-coordinate, the securing section would then be arranged at a Z-coordinate which is shifted even further into the positive with respect to the end face.

The guide section therefore takes on, as a further function, the axial securing of the operating ring on the base ring along the Z axis or the longitudinal axis of the jointly formed feed-through opening.

In a preferred embodiment of the signal transmitter of the invention, it is provided that the guide section comprises a securing catch which can be displaced between a securing position and an assembly position, wherein the securing catch protrudes at least in sections into the feed-through opening in the assembly position and is arranged completely outside the feed-through opening in the securing position. Furthermore, in this case, when the annular operating element is joined to the annular transmitter base and the securing catch is located in the securing position, the guidable section is arranged along the longitudinal axis at least in certain sections between the securing catch and the annular transmitter base. Furthermore, in this case, when the annular operating element is joined to the annular transmitter base and the handlebar of the bicycle is accommodated in the feed-through opening, the securing catch is pushed by the handlebar into the securing position.

The securing catch can belong to the above-mentioned securing section or form the same. In principle, the displacement of the securing catch can take place in an articulated or elastic manner.

Preferably, the securing catch is elastically mounted and a constituent of the preferably structurally elastic securing section of the guide section. Preferably, the securing section with the securing catch is an integral constituent of the guide section. Particularly preferably, the securing catch can be displaced out of the securing position into the assembly position under elastic deformation of the securing section, which, by implication, implies a certain self-holding effect of the securing catch in the securing position. Therefore, there is a certain pre-securing, even without the handlebar being guided through the feed-through opening. This may for example facilitate the pre-assembly of the operating ring on the base ring, before the actual securing takes place by means of the final assembly on the handlebar. The final assembly takes place in that the handlebar is arranged in the feed-through opening and in the process, the elastic or possibly articulated displacement of the securing catch into the feed-through opening is prevented.

In a preferred embodiment of the signal transmitter of the invention, it is provided that at least one magnet is arranged in each of the annular transmitter base and of the annular operating element in such a manner that, due to their interaction, the annular operating element is held in the neutral position.

One magnet in each of the base ring and of the operating ring can also be considered as a magnet pair. Preferably, a multiplicity of magnets or magnet pairs can be provided in the operating ring and in the base ring, particularly preferably at regular intervals.

This is beneficial for a simple assembly of the base ring with the operating ring and for secure holding of the operating ring in the neutral position or for a secure return to the neutral position following an operating action. Particularly preferably, two, three, four or even more magnets or magnet pairs can be provided.

One or more such magnets can also interact with the at least one sensor or plurality of sensors to generate the transmitter signals.

It is particularly advantageous when using magnets—if these magnets are also used for holding the operating ring in the neutral position with respect to the base ring—that the shifting feel is particularly user friendly for the rider. Thus, in the neutral position, the operating ring and the base ring can be held together with a maximum magnetic force (cohesive force). As soon as the rider would like to upshift or downshift for example, that maximum magnetic force (cohesive force) must be overcome. The cohesive force gets smaller and smaller in the course of the movement however, as the two corresponding magnets are moved further and further away from one another. Thus, a particularly intensive “crisp” shifting feel is created for the rider at the start of the shifting movement, whilst, in the course of the shifting movement, the force to be applied decreases further and further. This is the opposite of conventional mechanical shifting mechanisms, in which the rider regularly has to apply the highest force or at least a higher force at the end of the shifting movement and to finally realize the shifting process than at the start of the shifting movement.

In a preferred embodiment of the signal transmitter of the invention, it is provided that the at least one sensor is designed as a magnet-sensitive sensor and arranged in the annular transmitter base, wherein the magnet-sensitive sensor can be excited by at least one/the magnet allocated to the annular operating element to generate specific transmitter signals when the annular operating element, starting from the neutral position, executes a rotational movement in a first direction, a rotational movement in a second direction or a tilting movement.

The magnet-sensitive sensor therefore generates the transmitter signals which in each case correspond to a specific rotational movement or tilting movement of the annular operating element. The signal transmitter of the invention can to this end also comprise a plurality of, for example two or three, such magnet-sensitive sensors. For example, in each case one of the three magnet-sensitive sensors can be provided for detecting the rotational movement in the first direction, in the second direction and for the tilting movement.

This can preferably be achieved by a Hall sensor which outputs a Hall voltage as a measure for the respective movement. Further magnet-sensitive sensors are known to a person skilled in the art.

In principle however, already using a magnet-sensitive sensor, the rotational movement in the first direction, in the second direction and also the tilting movement can be detected. Magnets of different strength can be provided for this for example. With respect to a rotational position about the longitudinal axis of the common feed-through opening, these magnets of different strength are arranged, starting from the neutral position of the operating ring, for example in positively and negatively offset rotational positions in the operating ring, with respect to the magnet-sensitive sensor, which magnet-sensitive sensor is arranged at the neutral rotational position in the base ring.

If the operating ring is then rotated in the first direction, for example to the right, about the Z axis, the stronger magnet for example moves towards the magnet-sensitive sensor and the weaker magnet moves away from the magnet-sensitive sensor. The magnet-sensitive sensor is therefore overwhelmingly exposed to the stronger magnetic field of the stronger magnet. If, by contrast, the operating ring is rotated in the second direction, therefore in this example to the left, about the Z axis, the weaker magnet moves towards the magnet-sensitive sensor and the stronger magnet moves away from the magnet-sensitive sensor. The magnet-sensitive sensor is therefore overwhelmingly exposed to the weaker magnetic field of the weaker magnet. The magnetic fields of different strengths therefore allow a clear distinction between the first and second direction. If the operating ring is tilted for example, both the stronger and the weaker magnet move towards or away from the magnet-sensitive sensor, depending on the tilting direction and position of the magnets and the magnet-sensitive sensor. Here, it is assumed by way of example that both magnets move away from the magnet-sensitive sensor as a consequence of the tilting movement. The magnet-sensitive sensor is therefore exposed to a reduced extent to a resulting magnetic field of the stronger and weaker magnets as a consequence of the tilting movement. The resulting magnetic field then acting in a weaker manner on the magnet-sensitive sensor likewise allows a clear detection of the tilting movement.

On the basis of the described principles, a person skilled in the art is readily capable of independently determining a multiplicity of suitable arrangements of sensors and magnets which are suitable for the detection of a quantity of movements that are actually sought by the person skilled in the art and can generate corresponding specific sensor signals.

In a preferred embodiment of the signal transmitter of the invention, it is provided that the annular transmitter base has a flat placement surface for placing the annular operating element and the annular operating element comprises a first bearing section and a second bearing section, wherein the first bearing section, the second bearing section and the flat placement surface are arranged such that they interact in such a manner that:
1. the first bearing section bears flat against the placement surface and slides on the placement surface to carry out the rotational movement, whilst the second bearing section does not contact the placement surface when the annular operating element is in the neutral position, and
2. the second bearing section can be brought to bear against the placement surface, starting from the neutral position, to carry out the tilting movement, whilst the first bearing section lifts off the placement surface.

Accordingly, the placement surface of the base ring is designed in a flat manner and the bearing surface of the operating ring runs in essentially two bearing planes, which are angled with respect to one another, wherein an angle between the bearing planes defines the maximum possible tilting movement.

In this manner, geometrically unique functional surfaces for guiding the rotational movement and the tilting movement are available by means of active surface pairing, which at the same time can be produced simply and are integrated into the operating ring whilst keeping the compact design.

In a preferred embodiment of the signal transmitter of the invention, it is provided that between the second bearing section and the placement surface, a recess is formed, which preferably runs in a wedge-shaped manner, when the first bearing section bears flat against the placement surface.

A wedge angle of the wedge-shaped recess is here in turn definitive for the maximum possible tilting movement.

As it should be possible to tilt the operating ring and the base ring relatively to one another and a non-tilted or non-operated state usually makes up the largest proportion of time in the life cycle of the signal transmitter, a functional gap can be present between base and operating ring for this proportion of time. The functional gap is for example formed by the previously described wedge-shaped recess. It may therefore be advantageous if the operating ring comprises a collar-like section, which surrounds the base ring at its external circumference, at least in sections, or at least extends over its outer curved surface, at least in sections, when the operating ring is joined to the base ring.

Exposure of the functional gap to the environment can be minimized by that enclosure with the collar-like section, which effectively protects the signal transmitter from external contaminants or humidity also.

Preferably, the operating section of the operating ring can also be arranged on the collar-like section.

In principle, it may be possible to realize a tilting movement of the operating ring by pressing or lifting the operating ring with respect to the base ring. In any case, by means of a tilting movement, a part of the operating ring can always be displaced away from the base ring, as a result of which an operating gap may still result. In order to seal both the functional gap and the operating gap to the outside, the one or also further collar-like sections can be correspondingly dimensioned and, if required, even surround the entire base ring at least in sections at its external circumference.

A further aspect of the invention relates to a method for assembly of a signal transmitter for a shifter apparatus for a bicycle, preferably a shifter apparatus according to the invention according to the present disclosure, wherein an/the annular operating element is joined to an/the annular transmitter base, so that the annular transmitter base and the annular operating element together form a/the feed-through opening for accommodating the handlebar of the bicycle, wherein the operating element is brought into a/the neutral position on the annular transmitter base by at least one magnet.

The assembly can therefore be carried out very easily and securely, as only two parts have to be positioned and orientated relatively to one another. The magnet assists the assembly in this case, in that it pulls the operating ring into the correct position in an assisting manner. At the same time, it also forms a type of fail-safe function against an incorrect arrangement, in which the magnet does not hold the operating ring in the neutral position, as it is noticeable for an assembler whether the magnetic force is acting as intended. Provided that a handlebar is still not arranged in the feed-through opening, the assembly can be understood as pre-assembly, purely for conceptual differentiation of the states.

In a preferred embodiment of the method of the invention, it is provided that the annular transmitter base comprises a/the guide section and the annular operating element comprises a/the guidable section which guidable section is designed in a complementary manner to the guide section and that the handlebar of the bicycle is guided into the feed-through opening, as a result of which the guide section secures the annular operating element along the longitudinal axis of the feed-through opening by interacting with the guidable section.

This step can analogously also be understood as final assembly and can be executed simply and efficiently with only one action, using which the pre-assembled signal transmitter is secured on the handlebar as a sub-assembly.

For final fixing of the signal transmitter as a whole along the longitudinal axis of the handlebar, a set screw can for example be provided, using which a fixing section of the annular transmitter base is tightened around the handlebar in a further step. However, an adhesion-promoting surface can for example also be provided in the feed-through opening of the signal transmitter, made from rubber for example, so that the signal transmitter adheres sufficiently in its position on the handlebar.

A further aspect of the invention relates to a method for operating a signal transmitter, preferably a signal transmitter according to the invention according to the present disclosure, wherein an/the annular operating element is joined in a/the neutral position to an/the annular transmitter base and wherein the annular operating element is operated out of the neutral position at least to carry out one of the following movements:
carrying out a/the rotational movement relative to the annular transmitter base in a/the first direction about a/the longitudinal axis of a/the feed-through opening, or
carrying out a/the rotational movement relative to the annular transmitter base in a/the second direction about a/the longitudinal axis of a/the feed-through opening, or
carrying out a/the tilting movement relative to the annular transmitter base.

This operation can take place during operation by means of the rider of the bicycle or else at the manufacturer for testing the signal transmitter following pre-assembly or final assembly. Here, the mechanical properties or movements can advantageously be tested and corresponding specific transmitter signals can be generated for test purposes.

A further aspect of the invention relates to a shifter apparatus for a bicycle, comprising at least: a signal transmitter according to the invention according to the present disclosure, a control device for generating control signals from transmitter signals which can be generated by the signal transmitter, and a controlled system.

The controlled system may comprise diverse mechanical or electrical systems which may correspond to all of the expedient functions disclosed here and also further expedient functions in the bicycle sector.

The control device can be designed and configured in a correspondingly diverse manner, in that on the one hand it is operatively connected to the relevant systems and on the other hand comprises software which allocates particular functions to specific transmitter signals by means of suitable control signals.

In principle, these functions may even be configurable. Preferably, the control device comprises a suitable interface for this. The interface can for example be realized in a wired or wireless manner. The interface can for example be realized by a computer interface to an external computer (preferably at the manufacturer). The interface can however also be realized for example using a smartphone which is equipped with a corresponding app (preferably on the user side).

In a preferred embodiment of the shifter apparatus of the invention, it is provided that the controlled system comprises a shifting mechanism and at least one further apparatus of the bicycle, which can be activated, and that the control device is configured for the following:
to generate a control signal for upshifting the shifting mechanism from a transmitter signal which corresponds to a/the rotational movement of the annular operating element of the signal transmitter in a/the first direction,
to generate a control signal for downshifting the shifting mechanism from a transmitter signal which corresponds to a/the rotational movement of the annular operating element in a/the second direction, and
to generate a control signal for activating the further apparatus, which can be activated, from a transmitter signal which corresponds to a/the tilting movement of the annular operating element.

From the viewpoint of the rider of the bicycle when riding the bicycle, the first direction may preferably correspond to rotating the operating ring forwards. The second direction may preferably correspond to rotating the operating ring backwards. The tilting movement may preferably correspond to a tilting movement of the operating ring executed to the right using the left thumb or to the left using the right thumb, that is to say a tilting movement from the side towards the centre of the handlebar. As a further apparatus that can be activated, for example a light can be switched on or off or else a rechargeable-battery status of a bicycle battery can be displayed on a display of the bicycle by means of the tilting movement.

A further aspect of the invention relates to a bicycle comprising a shifter apparatus according to the invention according to the present disclosure.

With regards to possible embodiments of the signal transmitter, the shifter apparatus and the bicycle of the invention, it is noted that all of the features of these subjects disclosed in the description of the method according to the invention are also disclosed as their possible stand-alone features. Analogously, any method features disclosed with respect to these subjects according to the invention are also disclosed as possible stand-alone features of embodiments of the method according to the invention.

Fundamentally, it is true that all features which are disclosed here with reference to a particular embodiment can also be combined with other embodiments of the invention. This is also in particular true in part for individual features, provided that it is not explicitly noted here that an inseparable functional-technical relationship exists between certain features, which must be retained to realize the invention.

In the following, the invention is explained by way of example with reference to exemplary embodiments and schematic drawings. In the figures:

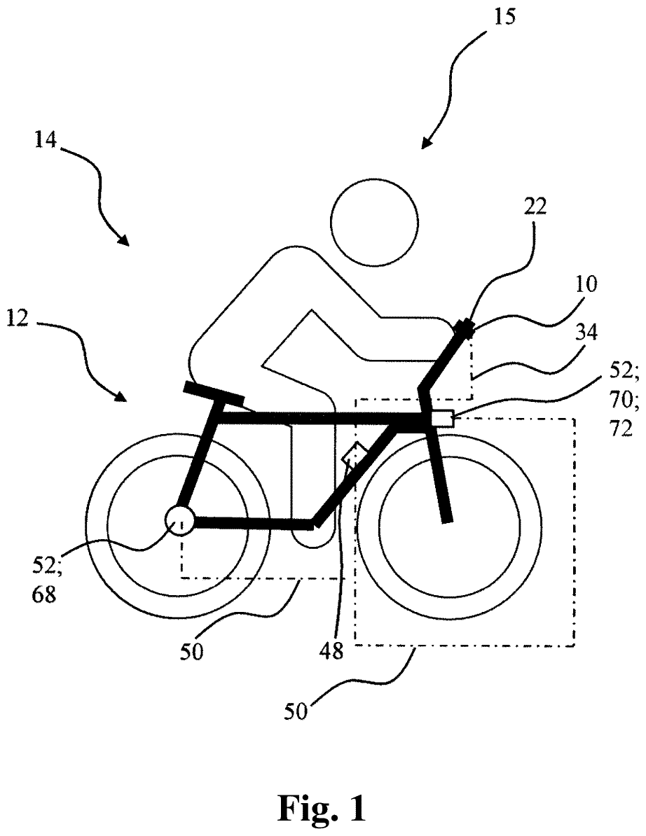

FIG. 1 shows a bicycle according to the invention;

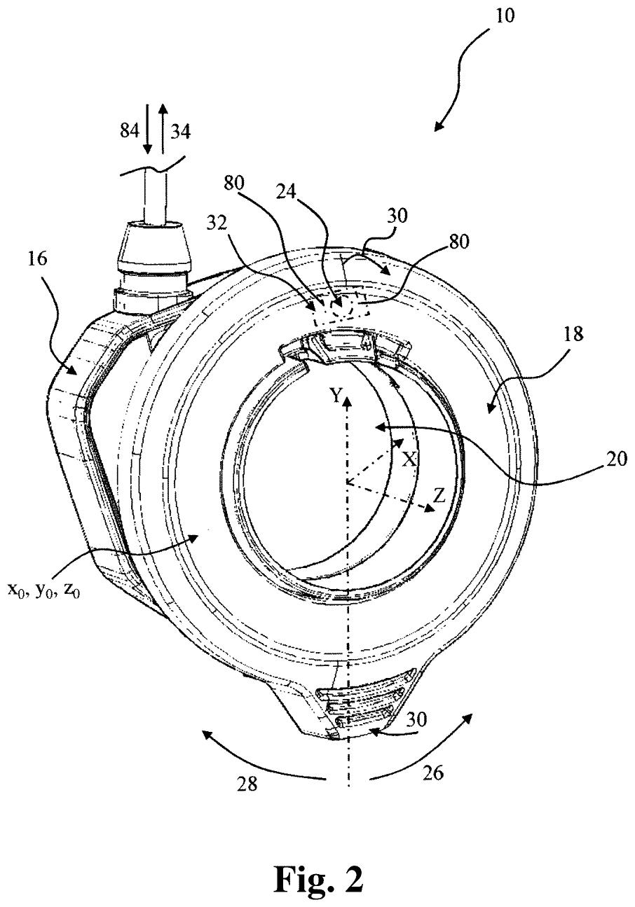

FIG. 2 shows a signal transmitter according to the invention in a perspective view;

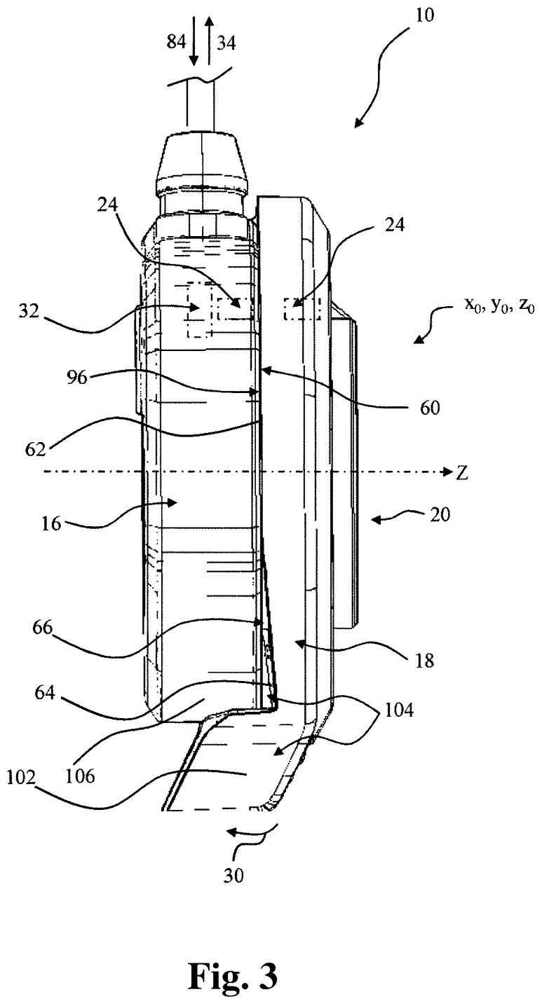

FIG. 3 shows the signal transmitter in a side view;

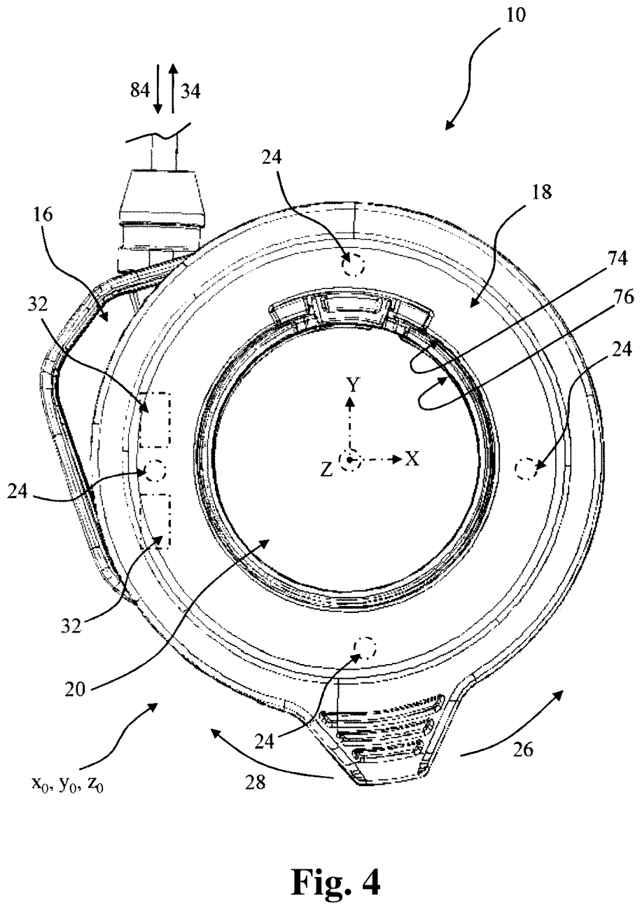

FIG. 4 shows the signal transmitter in a plan view;

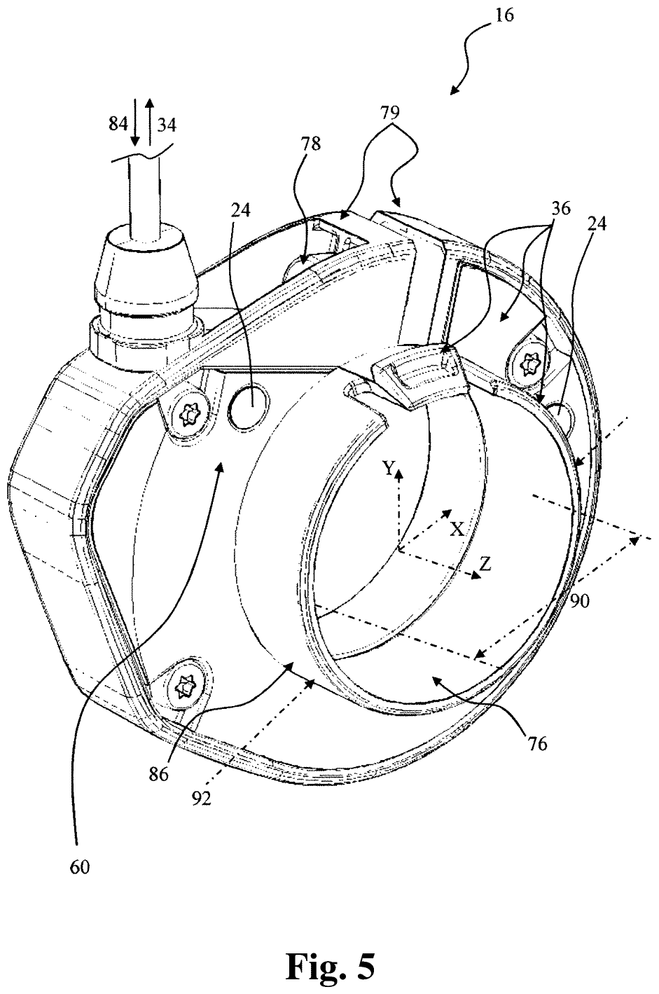

FIG. 5 shows an annular transmitter base of the signal transmitter;

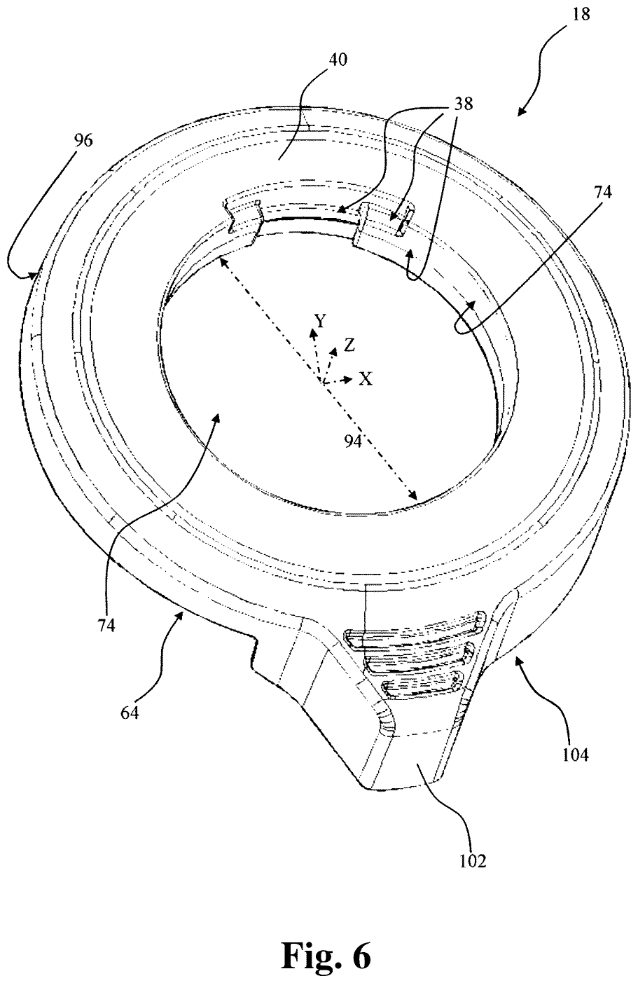

FIG. 6 shows an annular operating element of the signal transmitter;

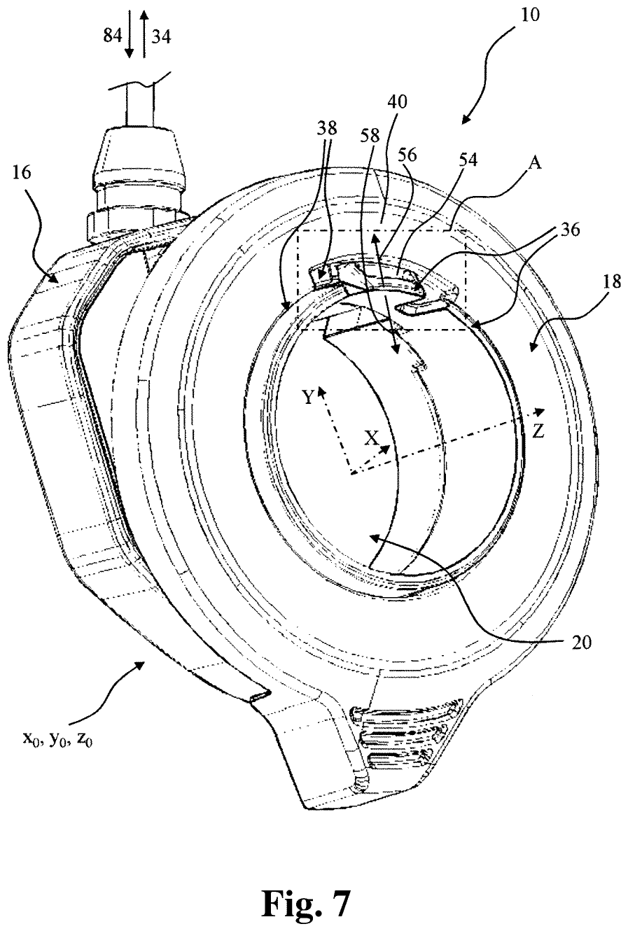

FIG. 7 shows the signal transmitter in a further perspective view;

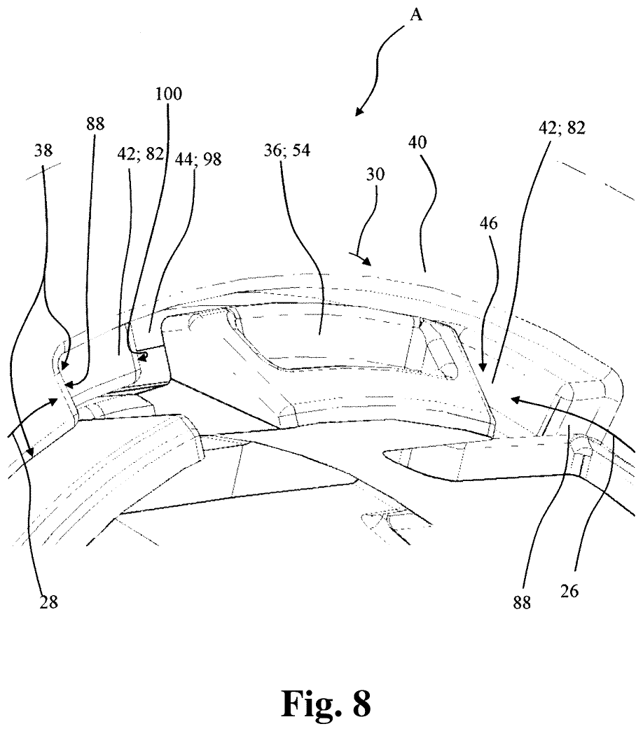

FIG. 8 shows an enlarged view of the Detail A from FIG. 7;

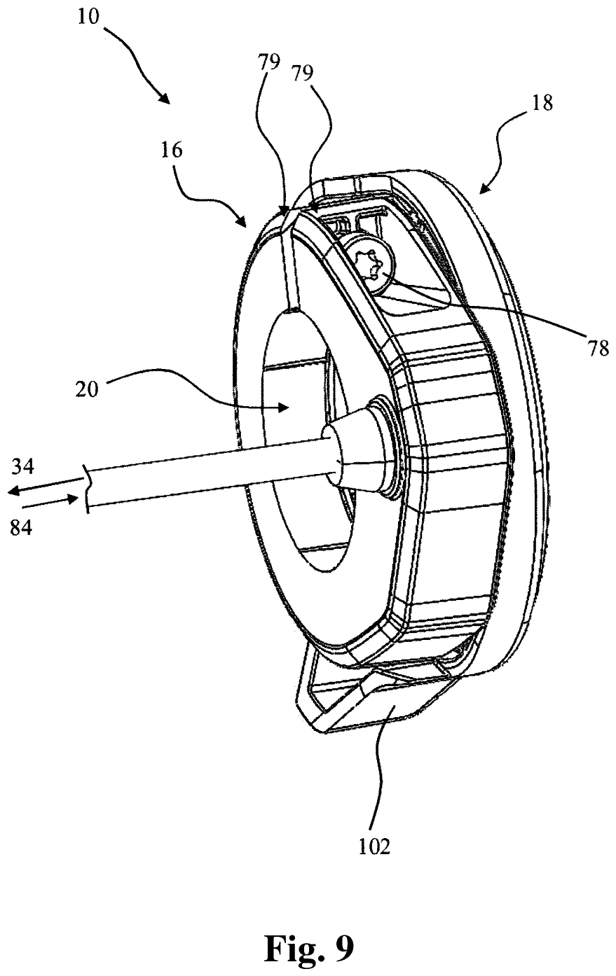

FIG. 9 shows a further embodiment of a signal transmitter in a perspective rear view;

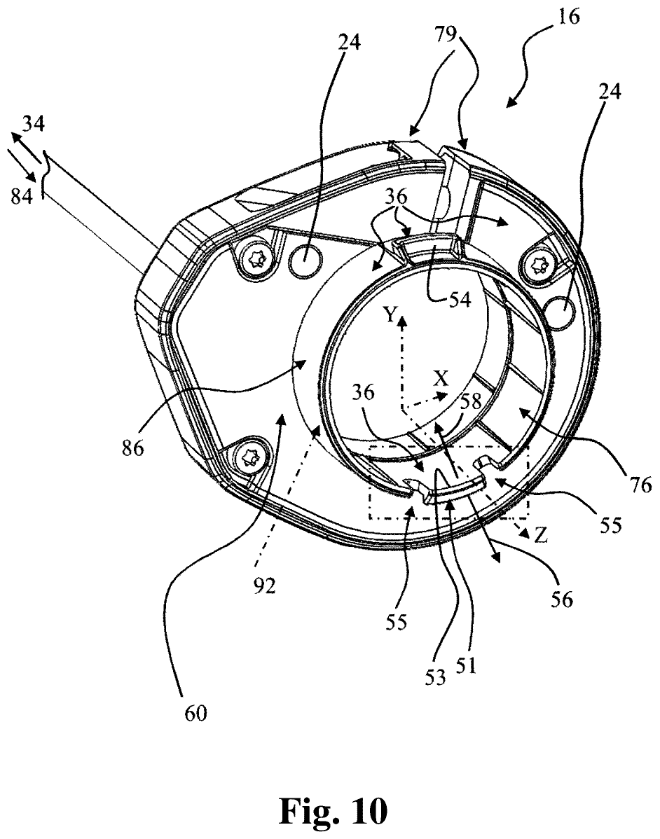

FIG. 10 shows the annular transmitter base of the signal transmitter from FIG. 9 in a perspective front view; and

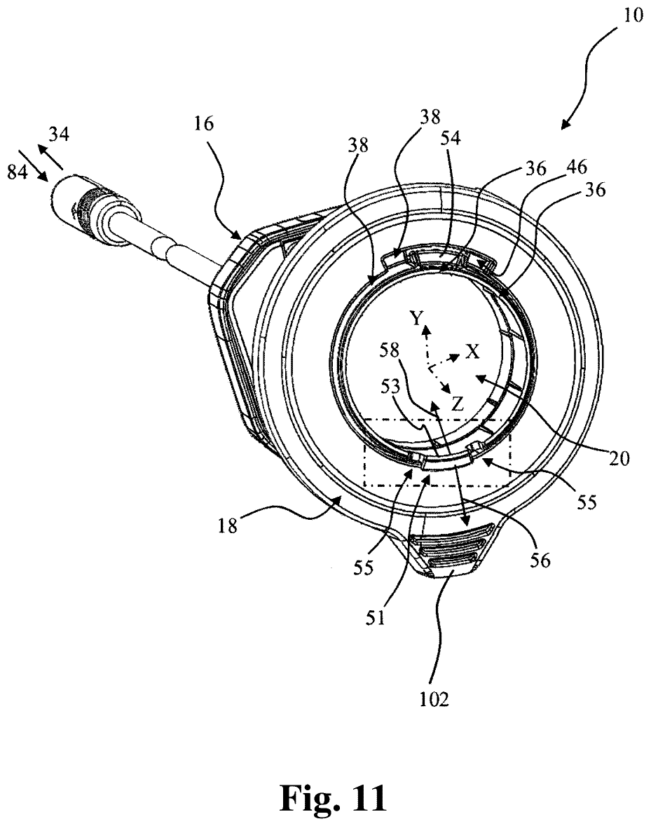

FIG. 11 shows the signal transmitter from FIG. 9 in a perspective front view.

FIG. 1 shows a bicycle 14 according to the invention, comprising a shifter apparatus 12 according to the invention. The shifter apparatus 12 comprises a signal transmitter 10 according to the invention, which is discussed in more detail in the following. The signal transmitter 10 is assembled on a handlebar 22 of the bicycle 14 here, purely by way of example.

The signal transmitter 10 is able to generate transmitter signals 34. The shifter apparatus 12 further comprises a control device 48 for generating control signals 50 from the transmitter signals 34 of the signal transmitter 10. Furthermore, the shifter apparatus 12 comprises a controlled system 52, which can be activated using the control signals 50. Purely by way of example, the controlled system 52 comprises a shifting mechanism 68 and a further apparatus 70 which can be activated, which further apparatus 70 is in the present case a lighting device 72, purely by way of example.

FIG. 2 shows a signal transmitter 10 according to the invention in a perspective schematic view. The signal transmitter 10 is intended for the shifter apparatus 12 of the bicycle 14 illustrated in FIG. 1, purely by way of example, and is described with reference to the same, without this being intended to be understood as limiting for the signal transmitter 10 of the invention.

In the following, FIGS. 1 to 8 are discussed as required and the signal transmitter 10 and its constituents are explained further. Accordingly, the same reference signs are used for all figures.

As shown in FIG. 2, the signal transmitter 10 comprises an annular transmitter base 16 and an annular operating element 18. The annular operating element 18 can also be termed an operating ring 18 and is joined to the annular transmitter base 16, which annular transmitter base 16 can also be termed a base ring 16.

As the annular operating element 18 is joined to the annular transmitter base 16, these jointly form a feed-through opening 20 for accommodating the handlebar 22 of the bicycle 14, as can be seen in FIG. 2, wherein the handlebar 22 extends through the feed-through opening 20, as indicated in FIG. 1.

As can be seen in FIG. 4, in which the signal transmitter 10 is shown in a plan view, the common feed-through opening 20 is formed by a feed-through opening 74 of the annular operating element 18 in concentric arrangement with a feed-through opening 76 of the annular transmitter base 16. For the purpose of further explanations, a coordinate system of the signal transmitter 10 is defined, comprising an X axis, a Y axis and a Z axis, wherein the Z axis at the same time also corresponds to a longitudinal axis of the feed-through opening 20. In FIGS. 2, 3, 4, 7 and 8, the annular operating element 18 is joined, with respect to this coordinate system, in a neutral position x0, y0, z0 to the annular transmitter base 16. In the neutral position x0, y0, z0, the annular operating element 18 is neither rotated nor tilted with respect to the transmitter base 16. This means that the coordinate system of the signal transmitter 10 in the neutral position x0, y0, z0 can be considered as identical to the own coordinate systems of the annular operating element 18 and the annular transmitter base 16. To simplify the illustrations, the coordinate system of the signal transmitter 10 as a whole is consistently taken into account in FIGS. 5 and 6, since, as has just been explained, the coordinate systems of the base ring 16 and the operating ring 18 match this in the neutral position x0, y0, z0.

The annular operating element 18 has at least one magnet 24 and is configured in such a manner that the annular operating element 18 is held in the neutral position x0, y0, z0 on the transmitter base 16 by the at least one magnet 24. To this end, in a few embodiments, the annular transmitter base 16 may for example comprise a magnetically attractable material (not separately illustrated). However, as shown for example in FIGS. 3, 4 and 5, there may also be a plurality of magnets 24 distributed on the annular transmitter base 16 and the annular operating element 18.

FIG. 3 shows the signal transmitter 10 in a side view and clarifies by way of example that in one possible embodiment a magnet 24 can be arranged both in the annular operating element 18 and in the annular transmitter base 16, wherein these magnets 24 then form a magnet pair in the neutral position x0, y0, z0. Due to the interaction of the magnets 24 forming the magnet pair, the annular operating element 18 is effectively held in the neutral position x0, y0, z0.

Basically, due to the magnetic attractive force of the at least one magnet 24, the annular operating element 18 is held in the neutral position x0, y0, z0 until a sufficiently large external force acts on the annular operating element 18 to move it out of the neutral position x0, y0, z0. After the external force has ceased, the annular operating element 18 then returns to the neutral position x0, y0, z0 again owing to the magnetic force.

The external force can for example be applied by a rider 15 of the bicycle 14 shown in FIG. 1, who carries out an operating action on the signal transmitter 10.

Starting from the neutral position x0, y0, z0, the annular operating element 18 can be operated here at least as indicated in FIG. 2:

On the one hand, a rotational movement in a first direction 26 or a rotational movement in a second direction 28 can optionally be carried out using the annular operating element 18 relative to the annular transmitter base 16 about the Z axis or the longitudinal axis of the common feed-through opening 20. On the other hand, a tilting movement 30 of the annular operating element 18 can be carried out relative to the annular transmitter base 16, which may for example correspond to a tilting movement 30 about the X axis.

The signal transmitter 10 in this case comprises at least one sensor 32 which reacts in a unique manner to the respective specific movement (reference signs 26, 28 or 30). The sensor 32 can preferably be designed as a magnet-sensitive sensor, for example as a Hall sensor. The sensor 32 is preferably arranged in the annular transmitter base 16, as shown for example in FIG. 3. As a magnet-sensitive sensor, the sensor 32 reacts accordingly to the magnetic field of the magnet 24 and as a result generates the transmitter signals 34 which are also indicated in FIG. 1, in each case specifically for the rotational movement in the first direction 26, rotational movement in the second direction 28 or tilting movement 30 of the operating element 18 indicated in FIG. 2.

Starting from the neutral position x0, y0, z0 shown in FIG. 2, the tilting movement 30 can for example be detected in that the magnet 24 moves away from the sensor 32, as is indicated in FIG. 2 by the curved arrow above the sensor 32, which represents the tilting movement 30. The influence of the magnetic field on the sensor 32 consequently becomes weaker, which can be detected as a tilting movement 30.

The rotational movement in the first direction 26 or the rotational movement in the second direction 28 can for example be detected, starting from the neutral position x0, y0, z0 shown in FIG. 2, in that the sensor 32 internally comprises two Hall voltage circuits 80 which are arranged laterally offset with respect to one another or left and right of the magnet 24 with respect to the neutral position x0, y0, z0. Depending on the rotational movement in the first direction 26 or rotational movement in the second direction 28, one of the Hall voltage circuits 80 then reacts first and/or more strongly than the other to the changing magnetic field of the magnet 24. This can correspondingly be detected as a specific rotational movement in the first direction 26 or in the second direction 28.

However, as shown by way of example in FIG. 4, a plurality of sensors 32 can also be used, which are arranged left and right of the magnet 24 with respect to the neutral position x0, y0, z0. FIG. 4 shows the signal transmitter 10 in the plan view with a view onto the X-Y plane of the coordinate system of the signal transmitter 10 or with a view in the negative Z direction. Here, it is also possible to see that the magnet 24 with the sensors 32 can, in one possible embodiment, also be arranged at a different position than for example shown in FIGS. 2 and 3. In addition, it is also indicated in FIG. 4 that a multiplicity of magnets 24, which may also belong to a multiplicity of magnet pairs, can be provided to hold the annular operating element 18 more securely in the neutral position x0, y0, z0.

FIG. 5 shows the annular transmitter base 16 and FIG. 6 shows the annular operating element 18, in each case separately in a perspective view.

Purely by way of example, it can be seen in FIG. 5 that the annular transmitter base 16 has a line for energy 84 and/or data or transmitter signals 34. The line can operatively connect the sensor 32 to the control device 48 from FIG. 1 for example.

Furthermore, purely by way of example, a set screw 78 is indicated, using which a fixing section 79 of the annular transmitter base 16 can be tightened around the handlebar 22, so that the signal transmitter 10 can be fixed finally on the handlebar 22 along the feed-through opening 20. The annular transmitter base 16 substantially consists of plastic, but may for example have a metal insert for accommodating the set screw 78. Also, elements such as the sensor 32 in the interior of the annular transmitter base 16 additionally consist of other materials. The same is true for the annular operating element 18, which substantially consists of plastic, but for example also has the magnet 24 which is made from metal.

FIG. 5 furthermore shows that the annular transmitter base 16 comprises a guide section 36. In this example, the guide section 36 comprises a placement surface 60 and a guide connecting piece 86 that protrudes from the same along the Z axis. The guide connecting piece 86 is involved in the shaping of the feed-through opening 76 of the annular transmitter base 16 and has an internal diameter 90. In the internal diameter 90, the guide connecting piece 86 can accommodate the handlebar 22. Before the features that have been mentioned are explained further, FIG. 6 is discussed in more detail.

Thus, FIG. 6 shows the annular operating element 18, which has a guidable section 38. The guidable section 38 is designed in a complementary manner to the guide section 36 of the annular transmitter base 16. The guidable section 38 is involved in the shaping of the feed-through opening 74 of the annular transmitter base 18 and has an internal diameter 94. The internal diameter 94 is preferably somewhat larger than an external diameter 92 of the guide connecting piece 86 (FIG. 5). Thus, the operating ring 18 can be pushed concentrically onto the guide connecting piece 86 and be tolerated such that it has the required clearance for carrying out the tilting movement 30 and rotational movements 26, 28, as explained previously.

Furthermore, the guidable section 38 comprises a bearing surface 96 which, although it is indicated with the reference sign 96 in the view of FIG. 6, cannot be seen directly, as it is opposite an end face 40 of the annular operating element 18, which can be seen in the foreground. The bearing surface 96 is joined as intended to the placement surface 60 (FIG. 5) and is then in contact with the same.

The guide section 36 of the base ring 16 and the guidable section 38 of the operating ring 18 therefore take on a multiplicity of functions and can in a wider sense also be interpreted as connecting means or connecting structures.

FIG. 7 shows the signal transmitter 10 in a further perspective view, in which the operating ring 18 is again joined to the base ring 16. Here, the guide section 36 interacts with the guidable section 38 in such a manner that whilst the rotational movement 26, 28 of the annular operating element 18 is being carried out relative to the annular transmitter base 16, starting from the neutral position x0, y0, z0 as indicated in FIG. 2 (reference sign 26 or 28), essentially no tilting movement 30 is possible. Analogously, whilst the tilting movement 30 of the annular operating element 18 is being carried out relative to the annular transmitter base 16, starting from the neutral position x0, y0, z0, essentially no rotational movement 26, 28 is possible.

This is achieved according to Detail A in FIG. 7 (rectangular section indicated by means of dot-dashed lines), which Detail A is illustrated enlarged in FIG. 8, in that the guidable section 38 comprises a recess 46 on the end face 40, which recess 46 runs in two planes at different depths, wherein the recess 46 in turn has a shallow plane 42 and a deep plane 44. As can be seen in FIG. 8, the deep plane 44 in this embodiment extends by way of example further in the negative Z direction from a base 82 of the shallow plane 42.

The guide section 36 is in engagement with the recess 46 in such a manner that the recess 46 restricts the rotational movement in the first direction 26 and the rotational movement in the second direction 28 and also prevents the tilting movement 30 on the shallow plane 42. This is achieved in that, although to carry out the rotational movement 26, 28 about the Z axis, the guide section 36 can slide over the base 82 of the shallow plane 42, at the same time, the base 82 as a stop prevents the tilting movement 30 forwards. The rotational movements 26, 28 are in turn restricted by side walls 88 of the shallow plane 42 as stops.

Alternatively, the rotational movements 26, 28 can be prevented and therefore the tilting movement 30 can be permitted. The tilting movement 30 is then possible forwards as far as the stop of the guide section 36 on a base 98 of the deep plane 44, wherein the rotational movements 26, 28 are prevented by side walls 100 of the deep plane 44 as stops.

In each case in interaction with the guide section 36, a movement separation is therefore achieved in this exemplary embodiment between the rotational movements 26, 28 and the tilting movement 30 by means of the base 82 of the shallow plane 42 and the side walls 100 of the deep plane 44 (in FIG. 8, only one of the two side walls 100 can be seen or is indicated by means of the corresponding arrow, as the further side wall is covered by the guide section 36 or the securing catch 54, which is explained below). Furthermore, a movement restriction is achieved by means of the side walls 88 of the shallow plane 42 and the base 98 of the deep plane 44.

As is further explained with reference to FIG. 7, it can furthermore be achieved with the aid of the guide section 36 in interaction with the guidable section 38 that the guide section 36 secures the annular operating element 18 along the longitudinal axis of the feed-through opening 20 or the Z axis when the handlebar 22 of the bicycle 14 is accommodated in the feed-through-opening 20.

This is achieved in the present case by way of example using a securing section in the form of an elastically mounted securing catch 54 of the guide section 36. With a brief review of FIG. 8, it is also this securing catch 54 which can be moved in a defined manner in the recess 46 to realize the movement separation and restriction.

As indicated in FIG. 7 by means of the two arrows 56 and 58 pointing in opposite directions, the securing catch 54 can be displaced between a securing position 56 (illustrated in FIG. 7) and an assembly position 58 (not illustrated in FIG. 7, but rather only indicated by means of the arrow 58). In the assembly position 58, the securing catch 54 protrudes at least in sections into the feed-through opening 20. This is only possible if the handlebar 22 is not located in the feed-through opening 20, as in the situation illustrated in FIG. 7. In FIG. 7, the securing catch 54 is however located just in the securing position 56, as can also be seen for example in FIG. 8.

In the securing position 56, the securing catch 54 is arranged completely outside the feed-through opening 20, which corresponds to the states shown in FIGS. 7 and 8. The securing catch 54 is therefore pushed outwards with respect to its radial position or the corresponding Y coordinate, wherein this forcing outwards can be realized just by means of a handlebar 22 extending through the feed-through opening 20. In the alternative assembly position 58 (not illustrated in FIG. 7 or FIG. 8, but rather only indicated by means of the arrow 58 in FIG. 7), the securing catch 54 is in turn displaced inwards with respect to its radial position or the Y coordinate, that is to say displaced in the direction of the Z axis or centre of the feed-through opening 20.

If, as shown in FIGS. 7 and 8, the annular operating element 18 is joined to the annular transmitter base 16 and the securing catch 54 is located in the securing position 56 shown, then the guidable section 38 is arranged along the longitudinal axis of the feed-through opening 20 or the Z axis at least in certain sections between the securing catch 54 and the annular transmitter base 16. It can be seen particularly well in FIG. 8 that the securing catch 54 is arranged in the negative Z direction directly in front of the base 98 of the deep plane 44.

If the handlebar 22 of the bicycle 14 is additionally accommodated in the feed-through opening 20, then the securing catch 54 is or remains pushed permanently into the illustrated securing position 56 by means of the handlebar 22.

In the following, FIG. 3 is discussed in more detail once more. There (and in FIG. 5), it is possible to see that the placement surface 60 of the annular transmitter base 16 is realized flat for placement of the annular operating element 18. Furthermore, the bearing surface 96 can also be seen in FIG. 3. In one embodiment, this bearing surface 96 can comprise a first bearing section 62 and a second bearing section 64.

The bearing surface 96 and the flat placement surface 60 interact in such a manner here that the first bearing section 62 bears flat against the placement surface 60 and slides on the placement surface 60 to carry out the rotational movements 26, 28, whilst the second bearing section 64 does not contact the placement surface 60.

By contrast, the second bearing section 64 can be brought to bear against the placement surface 60 to carry out the tilting movement 30, wherein the first bearing section 62 lifts off the placement surface 60. The bearing sections 62 and 64 can also be interpreted as angled bearing planes of the bearing surface 96. Accordingly, it is possible to see that a wedge-shaped recess 66 is formed between the second bearing section 64 and the placement surface 60 when the first bearing section 62 (as shown in FIG. 3) bears flat against the placement surface 60.

Once more additionally with reference to FIG. 6, it is further possible to see that the operating ring 18 can have an operating section 102 on its external circumference. In the present case, this is designed by way of example as an operating nub.

Furthermore, the second bearing section 64 can be seen to the left of the operating nub. To the right of the operating nub, by contrast, it is possible to see that the operating ring 18 comprises a collar-like section 104 on its external circumference, which extends further in the negative Z direction than the second bearing section 64. The operating nub or the operating section 102 can also be allocated to the collar-like section 104.

Using the collar-like section 104, the operating ring 18 can surround the base ring 16 at least in sections at its external circumference 106, as indicated in FIG. 3. The formation of gaps between operating ring 18 and base ring 16 can thus be minimized.

After the signal transmitter 10 according to the invention has been described in detail in a few embodiments, which can selectively be combined with one another without restriction, another method according to the invention for assembly of a signal transmitter should be described purely by way of example with reference to the signal transmitter 10 for the shifter apparatus 12 of the bicycle 14. The previous reference signs are therefore reused.

In the method, the annular operating element 18 from FIG. 6 is joined to the annular transmitter base 16 from FIG. 5, so that the annular transmitter base 16 and the annular operating element 18 jointly form the feed-through opening 20, which can be seen in FIG. 7. The operating element 18 is in this case held on the annular transmitter base in the neutral position x0, y0, z0 by the magnet(s) 24, as can be seen in FIG. 4 for example, preferably already guided into the neutral position x0, y0, z0 with the involvement of the magnet(s) 24.

To join the annular operating element 18 to the annular transmitter base 16, in a first step, the securing catch 54 is preferably first suspended in or pushed into the recess 46 or the recess 46 is hung over the securing catch 54 or pushed onto the same. Here, preferably for the suspension, the annular operating element 18 can also be tilted slightly with respect to the annular transmitter base 16. Preferably, for pushing on or in, the securing catch 54 can for example be manually bent elastically into the assembly position 58 (indicated in FIG. 7).

At the latest in a second step following that, the annular operating element 18 is brought to bear against the annular transmitter base 16, for example by folding on or placement and the securing catch 54 is allowed to spring back into the securing position 56 again, if appropriate.

In a further step, the handlebar 22 of the bicycle 14 is then guided into the feed-through opening 20, as a result of which the guide section 36 secures the annular operating element 18 along the longitudinal axis of the feed-through opening 20 or the Z axis in the described manner, particularly preferably by means of the securing catch 54.

Then, the set screw 78 can also be tightened and thus the position of the signal transmitter 10 can be fixed on the handlebar 22.

In turn, purely by way of example, another method according to the invention for operating a signal transmitter should be explained finally, with reference to the signal transmitter 10 for the shifter apparatus 12 of the bicycle 14, which signal transmitter 10 is for example assembled on the handlebar 22 as described. The previous reference signs are therefore reused again.

In the method, the annular operating element 18 is operated from the neutral position x0, y0, z0 to carry out at least one, preferably all of the movement(s) indicated in FIG. 2. This can comprise carrying out the rotational movement in the first direction 26 and, before that or after that, carrying out the rotational movement in the second direction 28. Finally, the method can also comprise carrying out the tilting movement 30 before that or after that.

With reference to FIG. 1, the control device 48 can preferably be configured to generate a control signal 50 for upshifting the shifting mechanism 68 from the rotational movement in the first direction 26. Furthermore, a control signal 50 for downshifting the shifting mechanism 68 can preferably be generated from the rotational movement in the second direction 28. From the tilting movement 30, a control signal 50 can preferably be generated for switching the lighting device 72 on or off as a further apparatus 70 that can be activated.

FIGS. 9 to 11 illustrate a further embodiment of a signal transmitter 10. Owing to the analogous mode of operation of the components, the same reference signs as before are used for the corresponding components (and the differences of the embodiment of FIGS. 9 to 11 compared to that according to FIGS. 1 to 8 are discussed in particular in the following). Reference is made to all three FIGS. 9 to 11 at the same time. In FIG. 10, for the sake of clarity and in particular for better understanding of the features of the base ring or the annular transmitter base 16, the operating ring or the annular operating element 18, which is to be seen in turn in FIGS. 9 and 11, has been hidden and omitted.

The illustrated signal transmitter 10 as proposed is here intended for the shifter apparatus 12 of the bicycle 14 illustrated in FIG. 1, purely by way of example, and is described with reference to the same, without this being intended to be understood as limiting for the signal transmitter 10 of the invention.

The signal transmitter 10 differs substantially in two aspects from the previously described signal transmitter 10 illustrated in FIGS. 1 to 8:

Thus, it is provided for the signal transmitter 10 according to FIGS. 9 to 11 that the line for energy 84 and/or data or transmitter signals 34 no longer leaves the ring radially, but rather in the axial direction, parallel to the z axis (Z). In this manner, the line runs away from the annular transmitter base 16 in the handlebar direction, parallel to the handlebar 22.

On the other hand, in the signal transmitter 10 according to FIGS. 9 to 11, a further snap hook 51 is provided, specifically on an underside (as viewed in the direction of the Y axis), where the operating section 102 is provided in the case of the annular operating element 18 (operating ring) which interacts with the annular transmitter base 16 (base ring). The annular transmitter base 16 has this snap hook 51. With its securing catch 53, the snap hook 51 ensures that the joined annular operating element 18 can no longer readily be removed axially from the annular transmitter base 16. The snap hook 51 is used as an axial securing device of the annular operating element 18, as was also illustrated and described in the exemplary embodiments of FIGS. 1 to 8 with respect to the elastically mounted securing catch 54 of the guide section 36. The upper guide section 36 or the upper securing catch 54 in the exemplary embodiment of FIGS. 9 to 11 is now, in contrast to the exemplary embodiment of FIGS. 1 to 8, no longer elastically mounted and displaceable between a securing position 56 and an assembly position 58 (only indicated by means of an arrow 58). This function and capacity to displace now (FIGS. 9 to 11) exists with respect to the lower snap hook 51, for example in that the snap hook 51 can be displaced into the assembly position 58, in which it protrudes at least in sections into the feed-through opening 20.

The upper securing catch 54 or the guide section 36 is in turn mainly only still used for guiding the rotational movements in circumferential directions, in order to output shifting commands or the like, or also for the third movement option of slight tilting of the operating ring with respect to the base ring. With respect to these three shifting movements (rotating the operating section 102 about the Z axis to the left, rotating to the right, tilting forwards against the Z axis), with regards to the securing catch 54 of the embodiment according to FIGS. 9 to 11, reference can also be made to the preceding description of the embodiment of FIGS. 1 to 8.

In FIG. 11, the snap hook 51 can be seen interacting with the joined operating ring 18 (in FIG. 10 without operating ring 18). The securing catch 53 of the snap hook 51 is in this case located just in the securing position 56. In the securing position 56, the securing catch 53 is arranged completely outside the feed-through opening 20. The securing catch 53 is therefore pushed outwards with respect to its radial position or the corresponding Y coordinate, actually downwards against the y axis, wherein this pushing outwards can likewise be realized by means of a handlebar 22 extending through the feed-through opening 20. In the alternative assembly position 58 (not illustrated in FIG. 11 or FIG. 10, but rather only indicated by means of the arrow 58), the securing catch 53 is in turn displaced inwards with respect to its radial position or the Y coordinate, that is to say displaced in the direction of the Z axis or in the direction of the centre of the feed-through opening 20.

If the handlebar 22 of the bicycle 14 is additionally accommodated in the feed-through opening 20, then the securing catch 53 is or remains pushed permanently into the illustrated securing position 56 by means of the handlebar 22.

For the design of the annular operating element 18 according to the exemplary embodiment of FIGS. 9 to 11, it is possible to refer to the illustration and description of the operating ring according to FIG. 6, or with respect to the elements of the annular operating element 18, it is also possible to refer to the further FIGS. 2 to 4, 7 and 8.

To join the annular operating element 18 to the annular transmitter base 16 in the exemplary embodiment of FIGS. 9 to 11, in a first step, the upper securing catch 54 is likewise preferably first suspended in or pushed into the recess 46 or the recess 46 is hung over the securing catch 54 or pushed onto the same. Here, preferably for the suspension, the annular operating element 18 can also be tilted slightly with respect to the annular transmitter base 16.

Afterwards, preferably for pushing the annular operating element 18 on or in, the lower securing catch 53 or the snap hook 51 can then be brought into engagement at the bottom with the annular operating element 18, actually with the circumferentially guidable section 38 there. For example, in this case, the securing catch 52 or the snap hook 51 can, in an assisting manner, manually be bent elastically into the assembly position 58 (indicated in FIG. 11). Alternatively, the annular operating element 18 can also be pushed all the way onto the annular transmitter base 16, against the counteracting force exerted by the securing catch 51, which in its base position is located not in the assembly position 58, but rather in the securing position 56. In the process, the elastically resilient securing catch 53 of the lower snap hook 54 automatically moves briefly into its assembly position 58 and snaps back into its securing position 56 again after passing the annular operating element 18.

To enable this resilient movement of the securing catch 53 into the assembly position 58 and back again into the securing position 56, a recess 55 is provided on each side for assistance, to the side of the securing catch 53. The recesses 55 are provided in the guide section 36 and ensure that the securing catch 53 is designed to be movable and to a certain extent bendable or pivotable. With respect to the exemplary embodiment according to FIGS. 1 to 8, this is configured analogously with regards to the guide catch 54. In the case of the upper guide catch 54 according to FIGS. 9 to 11, such recesses 55 are in turn not provided.

After the annular operating element 18 has been brought to bear against the annular transmitter base 16, for example by folding on or placement, the securing catch 53 is allowed to spring back into the securing position 56 again.

In a further step, the handlebar 22 of the bicycle 14 is then guided into the feed-through opening 20, as a result of which the guide section 36 secures the annular operating element 18 along the longitudinal axis of the feed-through opening 20 or the Z axis in the described manner, particularly preferably by means of the securing catch 53 of the snap hook 51.

### LIST OF REFERENCE SIGNS

10 Signal transmitter
12 Shifter apparatus
14 Bicycle
15 Rider
16 Annular transmitter base (base ring)
18 Annular operating element (operating ring)
20 Feed-through opening (formed jointly)
22 Handlebar
24 Magnet
26 Rotational movement in the first direction
28 Rotational movement in the second direction
30 Tilting movement
32 Sensor
34 Transmitter signal
36 Guide section
38 Guidable section
40 End face
42 Shallow plane
44 Deep plane
46 Recess
48 Control device
50 Control signal
51 Snap hook
52 Controlled system
53 Securing catch
54 Securing catch
55 Recess
56 Securing position
58 Assembly position
60 Placement surface
62 First bearing section
64 Second bearing section
66 Wedge-shaped recess
68 Shifting mechanism
70 Further apparatus that can be activated
72 Lighting device
74 Feed-through opening (of 18)
76 Feed-through opening (of 16)
78 Set screw
79 Fixing section
80 Hall voltage circuit
82 Base (of 42)
84 Energy
86 Guide connecting piece
88 Side wall (of 42)
90 Internal diameter (of 16)
92 External diameter
94 Internal diameter (of 18)
96 Bearing surface
98 Base (of 44)
100 Side wall (of 44)
102 Operating section
104 Collar-like section
106 External circumference
X X axis
Y Y axis
Z Z axis
x0, y0, z0 Neutral position

1-15. (canceled)

16: A signal transmitter for a shifter apparatus for a bicycle, the signal transmitter comprising:
an annular transmitter base;
at least one sensor which is configured to generate specific transmitter signals; and
an annular operating element which is configured to be joined to the annular transmitter base so that the annular transmitter base and the annular operating element jointly form a feed-through opening which is configured to accommodate a handlebar of the bicycle, the annular operating element comprising at least one magnet and being further configured so that the annular operating element can be or is held in a neutral position on the annular transmitter base by the at least one magnet and so that, starting from the neutral position, the annular operating element is operatable to:
perform a rotational movement of the annular operating element relative to the annular transmitter base in any direction about a longitudinal axis of the feed-through opening, and
perform a tilting movement of the annular operating element relative to the annular transmitter base,
wherein,
the specific transmitter signals generated by the at least one sensor correspond in each case to a specific rotational movement or to a specific tilting movement of the annular operating element.

17: The signal transmitter as recited in claim 16, wherein,
the annular transmitter base comprises a guide section,
the annular operating element further comprises a guidable section which is designed in a complementary manner to the guide section, and
the guide section is configured to interact with the guidable section so that, when the annular operating element is joined to the annular transmitter base, at least one of the following conditions is/are fulfilled:
while the rotational movement of the annular operating element is being performed relative to the annular transmitter base, starting from the neutral position, essentially no tilting movement is possible; and
while the tilting movement of the annular operating element is being performed relative to the annular transmitter base, starting from the neutral position, essentially no rotational movement is possible.

18: The signal transmitter as recited in claim 17, wherein,
the guidable section comprises a recess on an end face of the annular operating element, which recess runs in two planes at different depths,
the two planes which run at different depths are arranged as a shallow plane and as a deep plane,
the guide section is further configured to be brought into engagement with the recess so that the recess at least one of,
restricts the rotational movement and prevents the tilting movement on the shallow plane, and
prevents the rotational movement and restricts the tilting movement on the deep plane.

19: The signal transmitter as recited in claim 16, wherein,
the annular transmitter base comprises a guide section,
the annular operating element further comprises a guidable section which is designed in a complementary manner to the guide section, and
the guide section is configured to interact with the guidable section so that, when the annular operating element is joined to the annular transmitter base, that the guide section secures the annular operating element along the longitudinal axis of the feed-through opening when the handlebar of the bicycle is accommodated in the feed-through opening.

20: The signal transmitter as recited in claim 19, wherein,
the guide section further comprises a securing catch which is configured to be displaced between a securing position and an assembly position,
the securing catch is arranged to protrude at least in sections into the feed-through opening in the assembly position and is arranged completely outside of the feed-through opening in the securing position,
when the annular operating element is joined to the annular transmitter base and the securing catch is located in the securing position, the guidable section is arranged along the longitudinal axis at least in certain sections between the securing catch and the annular transmitter base, and
when the annular operating element is joined to the annular transmitter base and the handlebar of the bicycle is accommodated in the feed-through opening, the securing catch is pushed by the handlebar into the securing position.

21: The signal transmitter as recited in claim 16, further comprising:
at least one magnet arranged in the annular transmitter base,
wherein,
the at least one magnet of the annular operating element is arranged in the annular transmitter base, and
the annular operating element is held in the neutral position via an interaction between the at least one magnet arranged in the annular transmitter base the at least one magnet arranged in the annular operating element.

22: The signal transmitter as recited in claim 21, wherein,
the at least one sensor is configured as a magnet-sensitive sensor and is arranged in the annular transmitter base, and
the magnet-sensitive sensor is configured to be excited by at least one magnet of the annular operating element so as to generate the specific transmitter signals when the annular operating element, starting from the neutral position, executes the rotational movement in a first direction, the rotational movement in a second direction, or the tilting movement.

23: The signal transmitter as recited in claim 16, wherein,
the annular transmitter base comprises a flat placement surface which is configured so that the annular operating element is placeable thereon,
the annular operating element further comprises a first bearing section and a second bearing section, and
the first bearing section, the second bearing section, and the flat placement surface are arranged to interact so that:
the first bearing section bears flat against the placement surface and slides on the placement surface to carry out the rotational movement, while the second bearing section does not contact the placement surface when the annular operating element is in the neutral position; and
the second bearing section can be brought to bear against the placement surface, starting from the neutral position, to perform the tilting movement, while the first bearing section lifts off the placement surface.

24: The signal transmitter as recited in claim 23, further comprising:
a recess which is formed between the second bearing section and the placement surface when the first bearing section bears flat against the placement surface.

25: The signal transmitter as recited in claim 24, wherein the recess runs in a wedge-shaped manner.

26: A method for assembly of a signal transmitter for a shifter apparatus for a bicycle, the method comprising:
joining an annular operating element to an annular transmitter base so that the annular transmitter base and the annular operating element together form a feed-through opening for accommodating a handlebar of the bicycle,
wherein,
the annular operating element is brought into a neutral position on the annular transmitter base via at least one magnet.

27: The method as recited in claim 26, wherein the signal transmitter is the signal transmitter as recited in claim 16.

28: The method as recited in claim 26, wherein,
the annular transmitter base comprises a guide section, and
the annular operating element comprises a guidable section which is configured in a complementary manner to the guide section, and
further comprising:
guiding the handlebar of the bicycle into the feed-through opening so that the guide section secures the annular operating element along a longitudinal axis of the feed-through opening via an interaction with the guidable section.

29: A method for operating a signal transmitter, the method comprising:
joining an annular operating element in a neutral position to an annular transmitter base; and
operating the annular operating element out of the neutral position so as to perform at least one of,
a rotational movement relative to the annular transmitter base in a first direction about a longitudinal axis of a feed-through opening,
a rotational movement relative to the annular transmitter base in a second direction about the longitudinal axis of the feed-through opening, and
a tilting movement relative to the annular transmitter base.

30: The method as recited in claim 29, wherein the signal transmitter is the signal transmitter as recited in claim 16.

31: A shifter apparatus for a bicycle, the shifter apparatus comprising:
the signal transmitter as recited in claim 16;
a control device which is configured to generate control signals from the specific transmitter signals generated by the signal transmitter; and
a controlled system.

32: The shifter device as recited in claim 31, wherein,
the controlled system comprises a shifting mechanism and at least one further apparatus of the bicycle,
the at least one further apparatus of the bicycle is configured to be activated, and
the control device is configured to:
generate a control signal for upshifting the shifting mechanism from a transmitter signal which corresponds to the rotational movement of the annular operating element of the signal transmitter in a first direction;
generate a control signal for downshifting the shifting mechanism from a transmitter signal which corresponds to the rotational movement of the annular operating element in a second direction; and
generate a control signal for activating the at least one further apparatus from a transmitter signal which corresponds to a tilting movement of the annular operating element.

33: A bicycle comprising the shifter apparatus as recited in claim 32.
